(19) United States
(12) Patent Application Publication
(10) Pub. No.: US 2003/0002628 A1
(43) Pub. Date: Jan. 2, 2003

(54) Method and system for generating an electron beam in x-ray generating devices

(76) Inventors: Colin R. Wilson, Niskayuna, NY (US); Bruce M. Dunham, Mequon, WI (US); John Scott Price, Wauwatosa, WI (US)

Correspondence Address: ARTZ & ARTZ, P.C., 28333 TELEGRAPH RD., SUITE 250, SOUTHFIELD, MI, 48034, US

(21) Appl. No.: 09/681,931

(22) Filed: Jun. 27, 2001

(51) Int. Cl. H01J 35/14

(52) U.S. Cl. 378/138; 378/137; 378/136

(57) ABSTRACT

A field emission array electron source (12) is used to generate an electron beam in a x-ray generating device (10). The field emission array operates at room temperature and has a life expectancy in excess of 12,000 hours and provides a robust, efficient emitter for generating an electron beam in a x-ray generating device cathode (10).

### BACKGROUND OF INVENTION

The present invention relates generally to x-ray generating devices, and more particularly, to an improved x-ray generating device having a field emission array for generating the electron beam in the x-ray device.

Current x-ray generating device technology utilizes thermionic filaments typically made of tungsten. A single x-ray generating device will usually have more than one tungsten filament in an effort to provide several x-ray spot sizes for different applications. The tungsten filaments operate at high temperatures and have a typical short life expectancy on the order of several hundred to one thousand hours of operation. The life expectancy of the filament is limited due to the high operating temperature, which causes the tungsten filament to erode and deform. In addition, thermionic filaments require a high current supply to operate at such high temperatures.

Some thermionic filaments may have a complex filament design, i.e. a coil or a helix, modeled to tailor a temperature profile on the emitting surface. The electron emission current density is a function of the temperature. Precise control of the temperature implies a precise control of the focal spot current density and thus, the X-ray emission pattern. Some filaments are made from a flat tungsten sheet, rather than a tungsten coil. Prior art flat filaments provide a better focal spot than helical filaments. Also, electrons are emitted from hot edges. These electrons are difficult to focus and reduce the system efficiency and the quality of the focal spot. In an attempt to focus the electron beam, a bias voltage may be added to the cathode cup of the x-ray generating device. The bias voltage suppresses edge electrons and provides additional beam focusing.

It is generally desirable to improve the efficiency and performance of an x-ray generating device and to increase the life expectancy of the device. Additionally, it is desirable to reduce the complexity and cost of x-ray generating devices and the systems in which they are used.

### SUMMARY OF INVENTION

It is therefore one object of the invention to provide an x-ray generating device having a filament that operates at room temperature without the need for high currents. It is another object of the invention to provide a robust, low cost x-ray generating device. It is a further object of the present invention to provide an efficient x-ray generating device that has a life expectancy in excess of 1,000 hours.

In one aspect of the invention, a method and system is provided for generating an electron beam in a x-ray generating device. According to the present invention, the x-ray generating device has a field emission array (FEA) for generating the electron beam. The FEA usually operates at room temperature and is capable of generating a current density in excess of prior art thermionic emitters. According to the present invention, the electron beam is generated using bias voltages on the order of 50-100 V, for example. The bias voltage can be adjusted if necessary.

Other objects and advantages of the present invention will become apparent upon the following detailed description and appended claims, and upon reference to the accompanying drawings.

### BRIEF DESCRIPTION OF DRAWINGS

FIG. 1 is a perspective view of a an x-ray generating device having a FEA filament according to the present invention;

FIG. 2 is a cross-sectional view of the segment of x-ray generating device taken along line 2-2 in FIG. 1;

FIG. 3 is a cross-sectional view of the segment of x-ray generating device taken along line 3-3 in FIG. 2;

FIG. 4 is a perspective view of an array of field emitter cones;

FIG. 5 is a section view of a single cone taken along line 5-5 in FIG. 3;

FIG. 6 is a perspective view of an array of hollow cylindrical emitters;

FIG. 7 is a perspective view of an array of nanotube emitters;

FIG. 8 is a top view of the emitter of the present invention showing a large spot;

FIG. 9 is a top view of the emitter of the present invention showing a small spot;

FIG. 10 is a top view of the emitter of the present invention showing a bias voltage applied to a right portion of the emitter; and FIG. 11 is top view of the emitter of the present invention showing a bias voltage applied to a left portion of the emitter.

### DETAILED DESCRIPTION

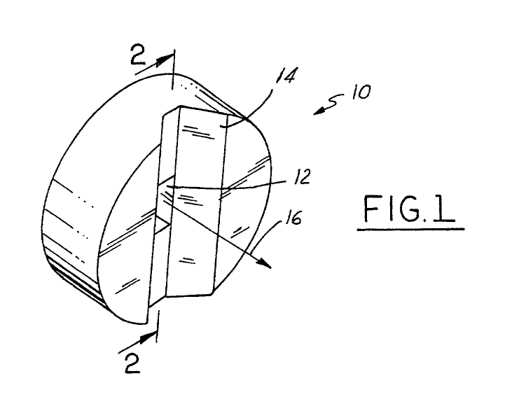

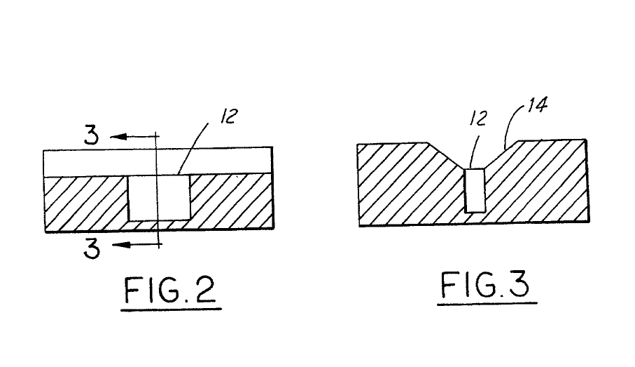

In the following figures the same reference numerals will be used to identify the same components in the various views. Referring now to FIG. 1, there is shown a perspective view of the cathode portion 10 of an x-ray generating device having a field emission array electron source according to the present invention. FIG. 2 is a cross-sectional view of the x-ray generating device cathode 10 taken along line 2-2 of FIG. 1 and shows an electron source 12. FIG. 3 is a cross sectional view of the x-ray generating device cathode 10 and the source 12 taken along line 3-3 of FIG. 2. Referring generally to FIGS. 1-3, the electron source 12 is made of a field emission array electron emitter, which will be described in detail hereinafter. The x-ray generating device cathode 10 operates at room temperature using low gate voltage field emission and therefore does not require an additional high current thermionic filament supply that typically adds cost and complexity to the operation of the generating device 10.

The FEA source 12 emits an electron beam that propagates in a direction indicated by reference number 16 in FIG. 1. The electron beam can be focused by a generally concave-shaped portion 14 of the x-ray generating device cathode 10. The concave shape 14 is located on a portion of the cathode 10 that is facing the direction of propagation for the electrons in the electron beam emitted by the source 12.

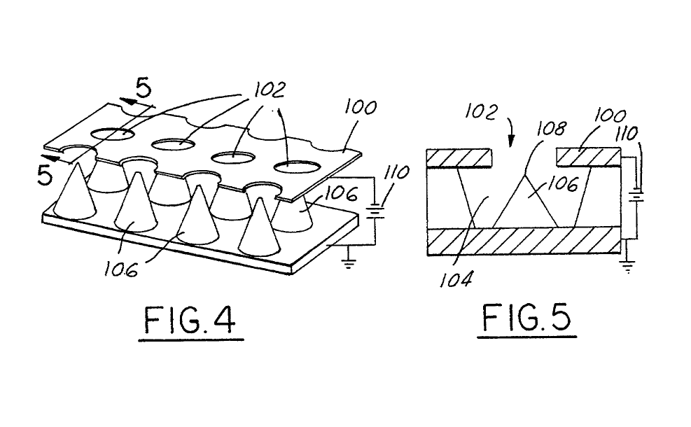

According to the present invention, the source 12 is a field emission array. Some background of field emission array (FEA) technology is useful in understanding the present invention and its advantages to x-ray generating device technology. FEA's were originally developed for flat panel display devices, such as computer screens, television screens, etc. The FEA is fabricated by making a semiconductor/insulator/conductor sandwich. FIG. 4 is a perspective view of an array of emitters, shown as cones in FIG. 4. FIG. 5 is cross-sectional view taken along line 5-5 in FIG. 4. Referring to FIG. 4 a top conductor 100, or gate, has openings 102 etched therein. The openings 102 are typically on the order of 1 to 3 microns in diameter. Inside each opening 102 is a cavity 104 and an emitter 106, the emitter has a sharp cone form. The cone s typically made of a suitable metal such as molybdenum.

The emitters are arranged in an array as shown in FIG. 4, which would make up the filament of the present invention. Each emitter has an effective emitting area, typically on the order of 1.2×10⁻¹⁵ cm² and is capable of producing 50-150 microamps of current when an electric field at the tip 108 (see FIG. 5) of the emitter is sufficiently high. Current technology for fabricating the FEA's can produce cone-packing densities in excess of 6.4×10⁵ cones/cm² and therefore total current densities of over 10 A/cm². These densities are far higher than current thermionic cathodes. The difference is that instead of a single electron gun spraying electrons that are focused into an electron beam, there are as many as 500 million cones 106 in an array spraying electrons.

Field emitter arrays have been formed using the Spindt technique in which a metal, such as molybdenum, is evaporated into a masked hole in a dielectric. The evaporated metal is first filtered in order to form a very directional beam of material. The cone tips are fabricated using this or any other method known to one of ordinary skill in the art.

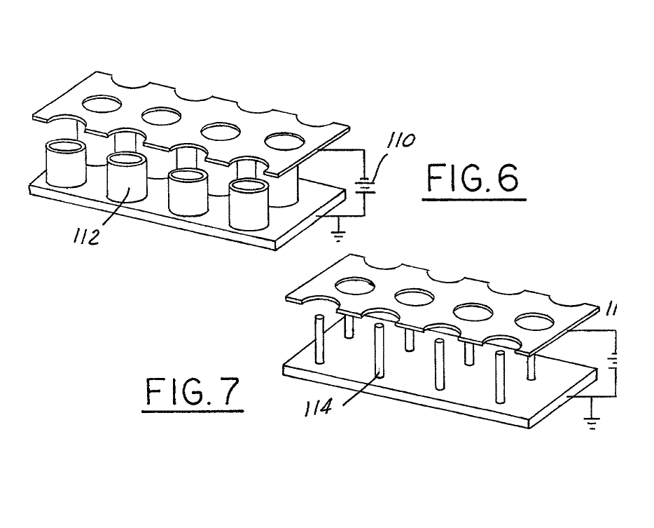

It should be noted that the Spindt emitter, i.e. the pointed cone at the center of a well formed by a hole in the anode layer, is not the only field emission arrayed emitter. There are several other alternatives that can be substituted for the Spindt emitter described herein that accomplish similar results. For example, hollow cylindrical structures 112, shown in FIG. 6, as well as other exotic types such as carbon nanotube emitters 114, shown in FIG. 7, that have a potential applied to a gate structure to produce emission may be substituted without departing from the scope of the present invention.

Using an FEA filament to generate the electron beam in a x-ray generating device according to the present invention provides many advantages. The FEA filament operates at room temperature, and is not a heat source. Therefore, the filament does not deform and erode by evaporation. The FEA filament is much more robust than the tungsten filament typically used in x-ray generating devices. In addition, it has been shown through testing that FEA's have a life expectancy in excess of 12,000 hours.

The electron emission is only produced on the upper surface of the FEA. Therefore, there are no edge effects in the x-ray generating device of the present invention. Prior art cathode designs are generally inefficient because they are known to be difficult to focus and have undesirable edge effects. Focusing electron beams in prior art x-ray generating devices is typically accomplished by suppressing electrons by adding bias to a cathode in the x-ray generating device. Without edge effects, the problems associated with focusing the electron beam in the prior art are not experienced with the present invention.

With reference to FIGS. 1 and 3 showing the generally concave shape 14 of the x-ray generating device 10 in an area surrounding the filament 12, which generally focuses the beam. For each emitter tip 108, the amount of electrons coming off the tip 108 are controlled by applying a bias voltage 110 between the tip 108 and the opening 102 as shown in FIGS. 4 and 5. A typical bias voltage may be on the order of 0 to 100 V. The electric field produced by the bias voltage also shapes the individual electron beam from the cone tip 108, also called a beamlet. The cathode cup shown in FIG. 6 focuses the beam that is made up of all the individual beamlets. The cup shapes the electric field between the cathode and the anode, or target, to get the desired beam size.

An FEA behaves like a perfectly isothermal surface. Therefore, when the same bias voltage is applied to each cone, the same amount of current is emitted. Prior art filaments typically require a complex filament design model to tailor a temperature profile for the emitting surface. This is not necessary for the filament in the present invention because it behaves like a tungsten filament having a uniform temperature, without the need for complex filament design.

The FEA filament used in the present invention has a very long life since it operates at room temperature. Therefore it is more robust than conventional tungsten filaments that are deformed by exposure to high temperatures. Moreover, only one filament is required in a generating device. Prior art generating devices typically have more than one tungsten filament, which not only increases the cost of the generating device, but also introduces coincidence problems. With the single FEA filament in the present invention, there are no coincidence problems.

In a practical application of prior art generating devices, more than one tungsten filament is used for procedures that require a large x-ray spot size and a small x-ray spot size. However, when there are two tungsten filaments side by side in a cathode cup as in the prior art, the resultant electron beams hit the target at slightly different locations. The distance between the spots on the target is called the coincidence distance. It is desirable to have a coincidence distance that is as close to zero as possible.

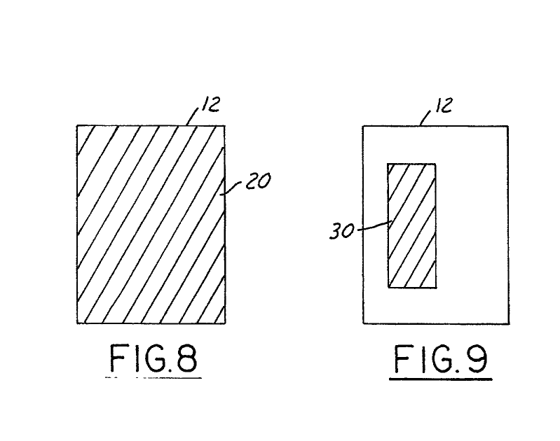

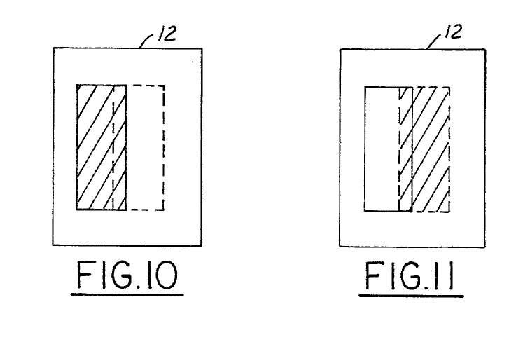

With current FEA technology it is possible to address each emitting emitter electronically. Therefore, it is possible to control the size of the emitting surface by producing a large spot size and a small spot size, both being centered on the same point in a cathode cup. According to the present invention, exciting a portion of the emitter array that less than the entire emitter array surface or exciting the entire emitter array surface allows control of the spot size. FIG. 8 is an example of a large spot 20 that is created by exciting the entire emitter surface. FIG. 9 is an example of a small spot 30 created by exciting only the middle portion of the FEA source. The coincidence distance is zero because both the large and the small spots come from the same location on the emitter and are subject to the same electric fields. Because of the elimination of multiple filaments for different sized spot rays, the present invention will allow the manufacture of substantially smaller cathode cups.

Further, the present invention can dynamically alter the beam shape by applying different bias voltages to different parts of the FEA electron source. For example, the power of the x-ray beam at a specific location may be increased or decreased merely by changing the bias voltage applied to that particular area of the FEA. Shaping the electron beam is an important feature in that it becomes possible to maximize the total power that the x-ray generating device can withstand.

In yet another embodiment of the present invention, the beam can by wobbled at high frequencies. Focal spot wobble is a highly desired feature for many applications including optimizing the performance of CT scanners. According to the present invention, individually addressing different areas of the emitter effectively wobbles the beam. FIGS. 10 and 11 are examples of wobbling the beam by applying the bias voltage the right side of the emitter, see FIG. 10, and then applying the bias voltage to the left side of the emitter, see FIG. 11. The bias voltages are applied alternatively at a predetermined frequency such that the beam wobbles from left to right. FIGS. 10 and 11 are only one example of many possible configurations for beam wobbling that would be configured according to a specific application, which one skilled in the art is capable of determining.

The FEA electron source according to the present invention generates the electron beam using simple, inexpensive electronic components, which will significantly reduce the cost of the generating device. Likewise, FEA electron sources can be made in large batches resulting in a further reduction in the cost of the generating device. For example, a FEA is produced as a fourteen square inch screen for flat panel displays sold in the consumer electronics market. Because the technology is used in the competitive consumer electronic market, the manufacturing cost must be low and therefore it is expected that the cost to manufacture the FEA filament for a x-ray generating device would also be low. New advances in the FEA manufacturing technology are improving the applicability of typical FEA's to vacuum levels and ion-backbombardment rates associated with the x-ray generating device further increasing the operating life of the x-ray generating device.

While the invention has been described in connection with one or more embodiments, it should be understood that the invention is not limited to those embodiments. On the contrary, the invention is intended to cover all alternatives, modifications, and equivalents, as may be included within the spirit and scope of the appended claims.

1. An x-ray generating device comprising:
a focusing cup;
an electron source housed within said focusing cup, said electron source comprising a field emission array emitter (FEA), said electron source generating an electron beam; and
a beam focusing structure arranged to focus said electron beam.

2. The x-ray generating device as claimed in claim 1 wherein said beam focusing structure further comprises said field emission array emitter having a plurality of field emitters arranged in a predefined pattern for focusing said electron beam and determining a focal spot for said electron beam.

3. The x-ray generating device as claimed in claim 2 wherein said plurality of field emitters further comprises a plurality of cone-shaped emitters.

4. The x-ray generating device as claimed in claim 2 wherein said plurality of field emitters further comprises a plurality of hollow cylinder shaped emitters.

5. The x-ray generating device as claimed in claim 2 wherein said plurality of field emitters further comprises a plurality of wire shaped emitters.

6. A method for generating an electron beam in an x-ray generating device comprising the steps of:
emitting electrons from an electron source in the x-ray generating device, said electron source being field emission array emitter;
focusing said electrons in a beam focusing structure to form the electron beam; and
determining a focal point for the electron beam.

7. The method as claimed in claim 6 wherein said step of focusing said electron beam further comprises focusing said electron beam in a beam focusing structure comprising a concave-shaped filament.

8. The method as claimed in claim 1 wherein said step of emitting electrons from an electron source further comprises the steps of:
applying a first bias voltage to a first predetermined portion of said FEA electron source; and
applying a second bias voltage to a second predetermined portion of said FEA electron source.

9. The method as claimed in claim 8 wherein said step of applying a second bias voltage to a second predetermined portion further comprises said first predetermined portion being larger than said second predetermined portion whereby said first predetermined portion defines a large spot having a center and said second predetermined portion defines a small spot having a center that coincides with said center of said large spot.

10. The method as claimed in claim 8 further comprising the step of applying a plurality of bias voltages to a plurality of predetermined portions of the FEA electron source whereby the power and shape of the electron beam are dynamically altered.

11. The method as claimed in claim 10 wherein said step of applying a plurality of bias voltages to a plurality of predetermined portions of the FEA further comprises applying a plurality of bias voltages to a plurality of predetermined portions comprising individual emitters of the FEA.

12. The method as claimed in claim 8 further comprising the step of shaping the electron beam by applying a plurality of different bias voltages to a plurality of different predetermined portions of said FEA electron source.

13. The method as claimed in claim 8 further comprising the step of focusing the electron beam in a beam focusing structure.

14. The method as claimed in claim 8 further comprising the step of alternating application of said first and second bias voltages at a predetermined frequency so as to wobble the electron beam in a predetermined pattern.

15. The method as claimed in claim 14 further comprising the step of focusing the electron beam in a beam focusing structure.

16. An x-ray generating device comprising:
a cathode cup;
an electron source housed within said cathode cup, said electron source comprising a field emission array emitter, said electron source generating an electron beam;
a beam focusing structure comprising a field emission array emitter having a plurality of field emitters arranged in a predefined pattern for focusing said electron beam and determining a focal spot for said electron beam;
a voltage source applied to said electron source for applying a predetermined bias voltage to a predetermined portion of said field emission array emitter whereby an electron beam is generated having a predetermined emission pattern.

17. The x-ray generating device as claimed in claim 16 wherein said predetermined pattern further comprises a concave-shaped pattern.

18. The x-ray generating device as claimed in claim 17 wherein said predetermined pattern further comprises a beam that is variable between a first portion of said field emission array emitter and a second portion of said field emission array emitter.

19. The x-ray generating device as claimed in claim 17 wherein said predetermined pattern further comprises a beam having a small spot pattern in which a portion of the field emission array emitter having a voltage applied thereto is less than the entire area of the field emission array emitter.
